(19) United States
(12) Patent Application Publication
(10) Pub. No.: US 2007/0136028 A1
(43) Pub. Date: Jun. 14, 2007

(54) Monitoring system for machine operable in a plurality of operating modes

(75) Inventors: Duane Winter, Gardnerville, NV (US); Raymond Jensen, Gardnerville, NV (US); Arvin Huck, Minden, NV (US); Amit Kandalgaonkar, Maharashtra (IN); Siddesh Vagal, Maharashtra (IN)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/298,572

(22) Filed: Dec. 12, 2005

(51) Int. Cl. G06F 11/30

(52) U.S. Cl. 702/182

(57) ABSTRACT

A monitoring system monitors a machine operable in a plurality of operating modes. The system includes an operating parameter module that controls operation of the machine according to predetermined operating parameters based on a current mode of operation. A monitoring parameter module applies applicable protection monitoring parameters based on the current mode of operation. The protection monitoring parameters are stored in the monitoring parameter module according to each of the plurality of operating modes. The system enables varying protection monitoring parameters to be applied for varying machine operating modes.

### BACKGROUND OF THE INVENTION

The present invention relates generally to machine monitoring systems and, more particularly, to a machine monitoring system that allows the user to configure multiple sets of monitoring parameters such that each set is specific to one or more of the machine's operating modes.

Many machines have multiple modes of operation. For example, hydro-electric pump-storage installations run both forward and backward and with widely varying loads. Aeroderivative power generation machines also operate in multiple modes including widely varying speeds, loads and temperatures. Current protection/monitoring systems allow users to configure only one set of monitoring parameters, which therefore is applied to all of the machine's operating modes. As a consequence, operational compromises are necessary that could degrade the amount of protection provided to the machine or negatively affect machine efficiency.

Currently, three methods are typically used to monitor a machine with multiple operating modes. One method involves temporarily inhibiting alarms, thereby leaving the machine temporarily unprotected. A second method temporarily applies a multiplication factor to the alarm set points. This affects all of the alarm set points in any given channel, and is thus not versatile. A third method involves reconfiguring the system with new parameters. This procedure, however, takes time and requires user intervention and generally leaves the machine unprotected for a period of time.

U.S. Pat. No. 6,859,739 and U.S. Pat. No. 6,678,639 describe state change indicators or monitoring systems. These patents, however, do not discuss a state-change monitor used for monitoring machines having multiple operating modes that varies its parameter sets based on a detected operating mode.

It would thus be desirable to provide a machine monitoring system that applies monitoring parameters based on a machine's specific mode of operation.

### BRIEF DESCRIPTION OF THE INVENTION

In an exemplary embodiment of the invention, a monitoring system monitors a machine operable in a plurality of operating modes. The monitoring system includes an operating parameter module communicating with the machine that controls operation of the machine according to predetermined operating parameters based on a current mode of operation. A monitoring parameter module, which communicates with the machine, stores protection monitoring parameters according to each of the plurality of operating modes, respectively. The monitoring parameter module applies applicable protection monitoring parameters based on the current mode of operation.

In another exemplary embodiment of the invention, a method of monitoring a machine operable in a plurality of operating modes includes the steps of (a) controlling operation of the machine according to predetermined operating parameters based on a current mode of operation; (b) determining the current mode of operation; (c) storing protection monitoring parameters according to each of the plurality of operating modes, respectively; and (d) applying applicable protection monitoring parameters based on the current mode of operation.

In yet another exemplary embodiment of the invention, an enhanced monitoring system is provided for a machine operable in a plurality of operating modes including at least one of forward, backward, varying loads, varying speeds, and varying temperatures. The monitoring system incorporates a signal processor that determines a current mode of operation via user input or via a signal from the machine. A monitoring parameter module, which communicates with the machine and the signal processor, stores sets of protection monitoring parameters input via a user interface according to each of the plurality of operating modes, respectively. An applicable protection monitoring parameter set is applied based on the current mode of operation, wherein upon a change in the current mode of operation based on a signal from the signal processor, the monitoring parameter module automatically effects a corresponding change in the applicable protection monitoring parameter set.

### BRIEF DESCRIPTION OF THE DRAWINGS

FIG. 1 is a schematic block diagram of the monitoring system in an exemplary embodiment of the invention; and

FIG. 2 is a flowchart of the monitoring system method.

### DETAILED DESCRIPTION OF THE INVENTION

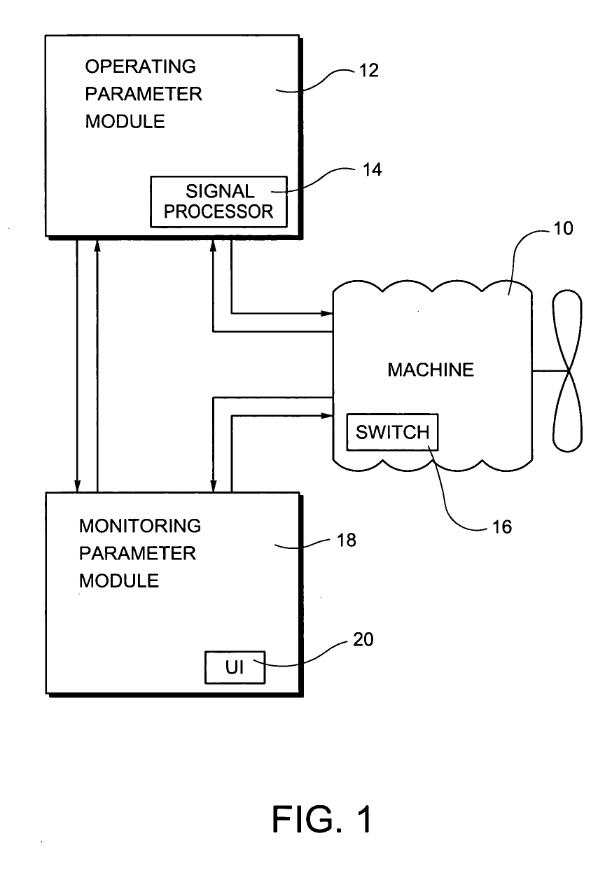

FIG. 1 is a schematic block diagram of an exemplary embodiment of the present invention showing a protection/monitoring system that a user can configure with multiple sets of protection/monitoring parameters, each set being tailored to match the requirements of a specific machine mode. A machine 10 operable in a plurality of operating modes is shown schematically. Examples of varying operating modes may include, without limitation, forward, reverse, unloaded, varying loads, varying speeds, varying temperatures and the like. For each operating mode, it is desirable to have the machine 10 run within specified levels of parameters such as vibration, temperature, load and speed. The levels are commonly referred to as alarm setpoints and are included in the monitoring parameters discussed herein. The system of the invention enables users to define monitoring parameters to meet specific requirements of each of the machine's operating modes.

An operating parameter module 12 embodying a control system controls operation of the machine 10 according to predetermined operating parameters based on a current mode of operation. The control system 12 comprises any appropriate high-powered solid-state switching device. As illustrated, the control system is schematically represented as a computer. However, this is merely exemplary of an appropriate high-powered control system, which is within the scope of the invention. For example but not limiting of the invention, the control system comprises at least one of a silicon controlled rectifier (SCR), a thyristor, MOS-controlled thyristor (MCT) and an insulated gate bipolar transistor, or the like.

In the illustrated embodiment, the control system is implemented as a single special purpose integrated circuit, such as ASIC, having a main or central processor section for overall, system-level control, and separate sections dedicated performing various different specific combinations, functions and other processes under control of the central processor section. It will be appreciated by those skilled in the art that the control system can also be implemented using a variety of separate dedicated or programmable integrated or other electronic circuits or devices, such as hardwired electronic or logic circuits including discrete element circuits or programmable logic devices, such as PLDs, PALs, PLAs or the like. The control system can also be implemented using a suitably programmed general-purpose computer, such as a microprocessor or microcontrol, or other processor device, such as a CPU or MPU, either alone or in conjunction with one or more peripheral data and signal processing devices. In general, any device or similar devices on which a finite state machine capable of implementing the flow charts, as illustrated in the application, can be used as the control system. As shown a distributed processing architecture is a preferred for maximum data/signal processing capability and speed. Such control apparatus are known and further details thereof will not be further described.

The control system 12 includes a signal processor 14 that communicates with the machine 10 to determine the current mode of operation. The signal processor 14 can determine the current mode of operation based on signals from the machine 10 and/or based on a position of a switch 16 (shown in position 2 in FIG. 1) on the machine 10.

A monitoring parameter module 18 communicates with the machine 10 and performs a monitoring function. The monitoring parameter module 18 stores protection monitoring parameters according to each of the plurality of operating modes, respectively. In this context, the monitoring parameter module 18 monitors parameters such as vibration, temperature, load and speed and compares their current levels to the predefined monitoring parameters. When any of these parameters is exceeded, the monitoring system 18 will take a predefined course of action. One course may be to inform the control system 12 that the machine 10 is operating in an undesirable state. Another course may be to take actions to remove the machine 10 from that undesirable state. The structure of such monitoring apparatus are known and further details thereof will not be described.

After receiving indication from the signal processor 14 of the current operating mode, the monitoring parameter module 18 applies applicable protection monitoring parameters based on the current mode of operation. Upon a change in the current operating mode, the monitoring parameter module 18 effects a corresponding change in the protection monitoring parameters. In one arrangement, the monitoring parameter module 18 includes a user interface 20 that permits a user to define and store the protection monitoring parameters for each of the machine operating modes.

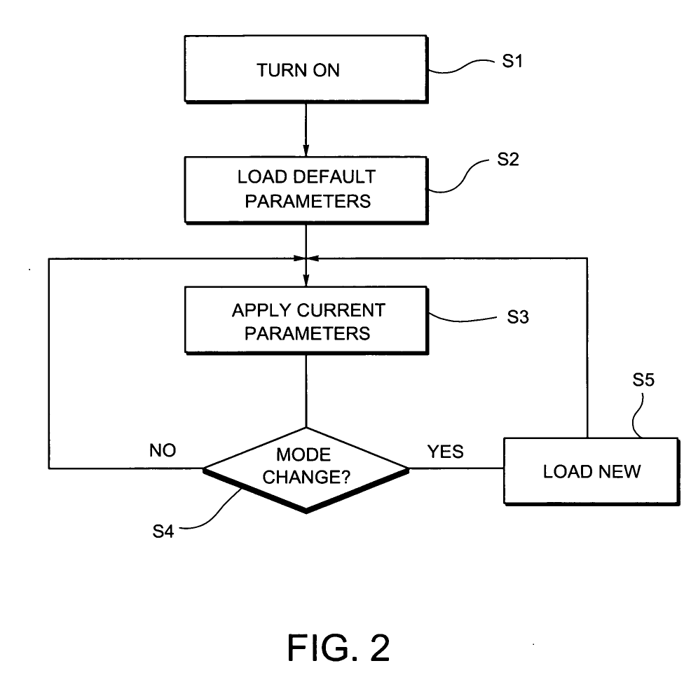

FIG. 2 is a flowchart for reference in describing an operation of the monitoring system. After turning on the monitoring system 18 (step Sl), the system automatically loads the predefined monitoring parameters for the default mode from the stored parameter sets (step S2). The monitoring system 18 will then apply the loaded monitoring parameters (step S3) as it monitors the condition of machine 10. The monitoring system 18 continuously checks for mode-change commands from the control system 12 (step S4). If no mode change is detected, the monitoring system 18 continues to apply the currently loaded parameters. If a mode change is detected (YES in step S4), the monitoring system 18 automatically loads new parameters from the stored sets based on the detected operating mode (step S5) and applies the loaded parameters as it monitors the condition of the machine 10 (step S3).

Since the multiple sets of protection monitoring parameters are already configured into the system, the system can react rapidly to requests from the operator or operating parameter module to change parameter sets. This change occurs automatically, and very little or no human interaction is required. The system thus provides monitoring capabilities with specific protection monitoring parameters for each operating mode of a machine.

In an exemplary application, the system via the monitoring parameter module 18, in addition to utilizing a specific parameter set for a specific operating mode, is capable of changing an algorithm used to calculate the monitoring parameter levels, e.g., vibration/temperature/load levels. The algorithms are stored in the monitoring parameter module 18 and are correlated with a corresponding operating mode. This function may be employed for hydro-electric pump-storage applications. In this context, the rotor has poles on it which are numbered in numerical order. If the machine spins one direction, the numbers ascend; if the machine spins the opposite direction, the numbers descend. The monitoring parameter module 18 is programmed to identify which poles have the largest and smallest clearance to the stator depending on a direction of rotor spin. In aeroderivative and other applications, the invention could apply different filters to the input signals for each mode.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A monitoring system for a machine operable in a plurality of operating modes, the monitoring system comprising:
an operating parameter module communicating with the machine, the operating parameter module controlling operation of the machine according to predetermined operating parameters based on a current mode of operation;
a monitoring parameter module communicating with the machine, the monitoring parameter module storing protection monitoring parameters according to each of the plurality of operating modes, respectively, and applying applicable protection monitoring parameters based on the current mode of operation; and
a signal processor communicating with the machine and the operating parameter module, wherein the signal processor determines the current mode of operation based on at least one of signals from the machine and a position of a switch on the machine.

2-3. (canceled)

4. A monitoring system according to claim 1, wherein the plurality of operating modes comprise at least one of forward, backward, loaded and unloaded, and wherein the monitoring parameter module changes the protection monitoring parameters upon a change in the current operating mode.

5. A monitoring system according to claim 1, wherein the monitoring parameter module comprises a user interface that permits a user to define and store the protection monitoring parameters.

6. A monitoring system according to claim 1, wherein the operating parameter module comprises a control system.

7. A monitoring system according to claim 1, wherein the monitoring parameter module stores multiple algorithms for determining monitoring parameter levels, the monitoring parameter module applying one of the algorithms based on the current mode of operation.

8. A method of monitoring a machine operable in a plurality of operating modes, the monitoring method:
(a) controlling operation of the machine according to predetermined operating parameters based on a current mode of operation;
(b) determining the current mode of operation based on at least one of signals from the machine and a position of a switch on the machine;
(c) storing protection monitoring parameters according to each of the plurality of operating modes, respectively; and
(d) setting applicable protection monitoring parameters based on the current mode of operation determined in step (b).

9-10. (canceled)

11. A method according to claim 8, wherein the plurality of operating modes comprise at least one of forward, backward, loaded and unloaded, and wherein step (d) is practiced by changing the protection monitoring parameters upon a change in the current operating mode.

12. A method according to claim 8, further comprising permitting a user to define and store the protection monitoring parameters.

13. An enhanced monitoring system for a machine operable in a plurality of operating modes including at least one of forward, backward, varying loads, varying speeds, and varying temperatures, the monitoring system comprising:
a signal processor that determines a current mode of operation via user input or via a signal from the machine; and
a monitoring parameter module communicating with the machine and the signal processor, the monitoring parameter module storing sets of protection monitoring parameters input via a user interface according to each of the plurality of operating modes, respectively, and applying an applicable protection monitoring parameter set based on the current mode of operation, wherein upon a change in the current mode of operation based on a signal from the signal processor, the monitoring parameter module automatically effecting a corresponding change in the applicable protection monitoring parameter set.

14. An enhanced monitoring system according to claim 13, wherein the user input comprises a switch on the machine.

15. An enhanced monitoring system according to claim 13, wherein the operating parameter module comprises a control system.
